(19) United States
(12) Patent Application Publication
(10) Pub. No.: US 2007/0071919 A1
(43) Pub. Date: Mar. 29, 2007

(54) Laminated wooden container and its fabrication method

(75) Inventor: C. C. Jiang, Dali City (TW)

Correspondence Address: BACON & THOMAS, PLLC, 625 SLATERS LANE, FOURTH FLOOR, ALEXANDRIA, VA, 22314, US

(73) Assignee: HONG GENE TECH CO., LTD., Tali City (TW)

(21) Appl. No.: 11/237,985

(22) Filed: Sep. 29, 2005

(51) Int. Cl. B31B 45/00

(52) U.S. Cl. 428/34.1; 156/242; 156/312

(57) ABSTRACT

A laminated wooden container is made by sandwiching a bonding layer in between two wooden sheet members to form a laminated sheet material and then heat compressing and cutting the laminated sheet material under a predetermined temperature within 150° C. to 180° C. The bonding layer includes a base sheet material obtained from natural fibers, and a glue covered on two opposite surfaces of the base sheet material.

### BACKGROUND OF THE INVENTION

1. Field of the Invention

The present invention relates to the fabrication of food containers and more particularly, to a container fabrication method, which is practical for making laminated wooden food containers.

2. Description of the Related Art

Conventional disposable food containers include following five different type: Foamed Plastic Products, Degradable Plastic Products, and Paper Products. These products have drawbacks as outlined hereinafter:
1. Foamed Plastic Products: These products are commonly molded from foam EPS (polystyrene) that has a low hardness and low heat resisting power and, is not decomposable for more than one hundred year, and will release toxic substances when above 85° C. or burned. Therefore, these products are harmful to the environment and the immunological system of human beings.
2. Degradable plastic food containers: Plastic material is mixed with a photosensitive agent and a starch and processed into degradable material grains, and the degradable material grains are then molded into the desired degradable food containers. These products are water and oil proof, non-toxic, however its hardness is low. still has drawbacks as followed:
3. Paper food containers: These products are not protective against water and oil and have a low hardness. Therefore, these products can only be used to hold cold, dry food. Further, due to high reproduction cost, these products are not suitable for recycling and reproducing.

In order to eliminate the aforesaid drawbacks, laminated wooden containers are developed. These products may be made by using a bonding glue to bond two wooden or bamboo sheet members together through a hot compression molding process, or bonding a wooden sheet member to a fiber layer and then molding the laminated structure into the desired product through a hot compression molding process. These laminated wooden containers meet environment awareness requirements, and have non-toxic, decomposable, hard and heat resisting characteristics. However, these two methods still have drawbacks as follows:

The former method which uses a bonding glue to bond two wooden or bamboo sheet members together through a hot compression molding process cannot eliminate the permeation of the bonding glue into the tissues of the wooden or bamboo sheet members. Therefore, the finished products will crack easily. After hot compression molding, a post-processing is required to polish the coarsen surface and edge.

A finished product made according to the later method which bonds a wooden sheet member to a fiber layer and then mold the laminated structure into the desired product through a hot compression molding will not crack easily due to the support of the fiber layer. However, a container made according to this method is not suitable for holding hot water or food because the fiber layer will decompose at high temperature. It may contaminate the contained food when the container starts to decompose. Further, a product made according to this method has a coarsen edge, which must be polished through a secondary processing process.

### SUMMARY OF THE INVENTION

The present invention has been accomplished under the circumstances in view. It is therefore the main object of the present invention to provide a laminated wooden container, which is nontoxic, not harmful, strong, heat resisting, microwavable, freezable, decomposable, sturdy and rigid structure, and clean to the environment.

It is another object of the present invention to provide laminated wooden container fabrication method, which saves the manufacturing cost.

The method of making a laminated wooden container comprises the steps of: (a) preparing two wooden sheet members and a bonding layer; (b) laminating the two wooden sheet members and the bonding layer together to have the bonding layer be sandwiched between the wooden sheet members to form a laminated sheet material; (c) preparing a hot compression molding mold; and (d) heat compressing said laminated sheet material by using the hot compression molding mold to form a container.

### BRIEF DESCRIPTION OF THE DRAWINGS

FIG. 1 is a schematic drawing showing the processing of laminating the two wooden sheet members and the bonding layer together according to the present invention.

FIG. 2 is a schematic sectional view showing the use of a hot compression molding mold according to the present invention.

FIG. 3 corresponds to FIG. 2, showing the second die closed on the first die according to the present invention.

FIG. 4 is an elevated view of a laminated wooden container made according to the present invention.

FIG. 5 is a sectional view taken along line 5-5 of FIG. 4.

### DETAILED DESCRIPTION OF THE INVENTION

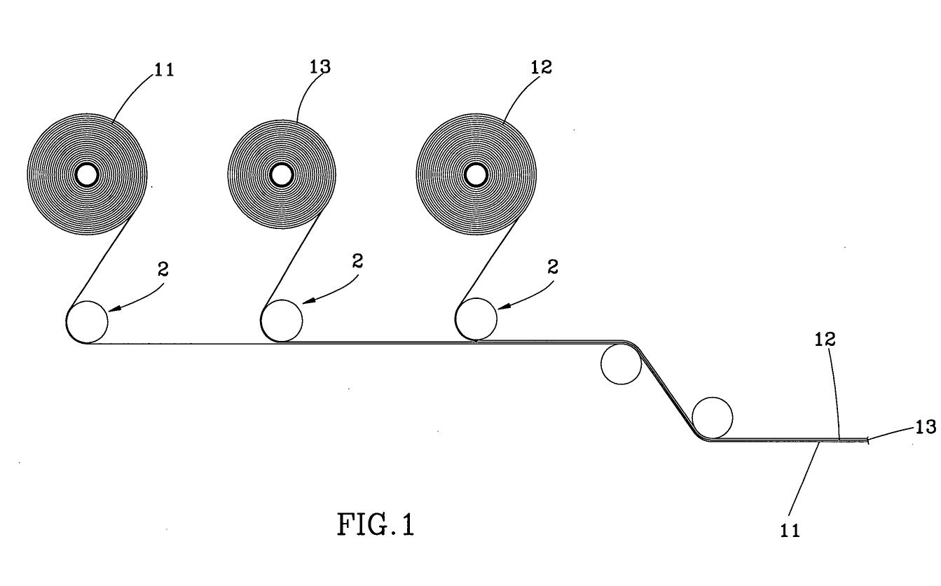

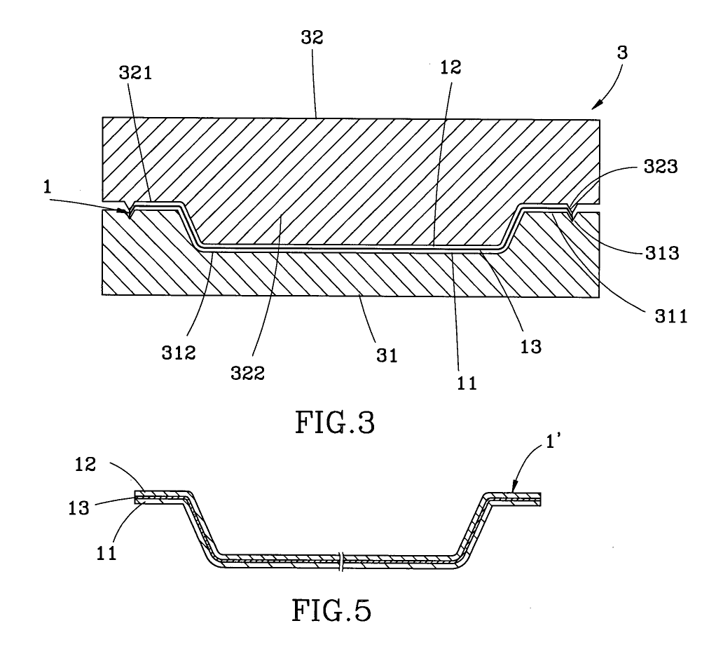

Referring to FIGS. 1-3, the method of making a laminated wooden container in accordance with the present invention comprises:

Step I: preparing two wooden sheet members 11, 12 and one bonding layer 13, where the wooden sheet members 11, 12 are respectively obtained from Albizia falcataria, each of the wooden sheet members 11, 12 having a thickness about 0.5 mm; the bonding layer 13 is obtained by covering the top and bottom surfaces of a base sheet material of recyclable natural long fibers with an eatable or biological glue by means of a coating or dipping technique;

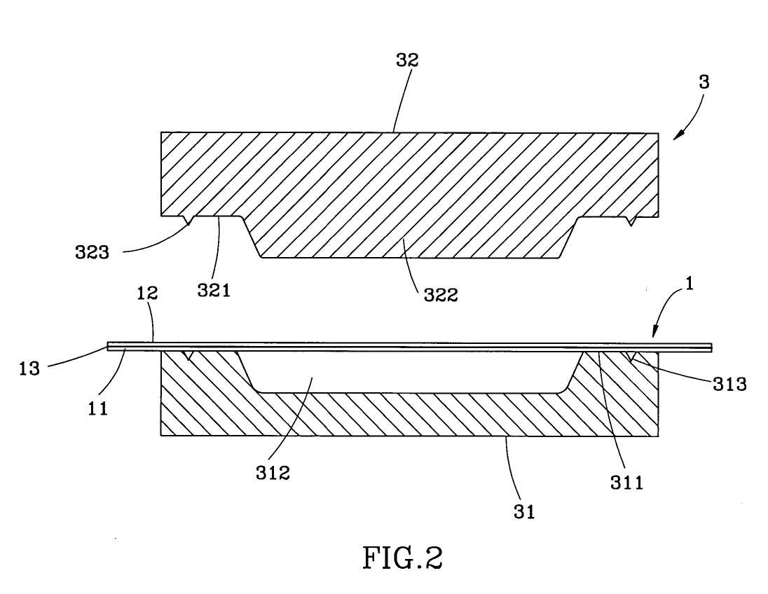

Step II: using rollers 2 to carry the wooden sheet members 11, 12 and the bonding layer 13 forwards and to have the wooden sheet members 11, 12 and the bonding layer 13 be laminated with the bonding layer 13 sandwiched between the wooden sheet members 11, 12, as shown in FIG. 1, and then cutting the laminated structure into a blank sheet material 1 having a predetermined length and width, as shown in FIG. 2;

Step III: preparing a hot compression molding mold 3, which comprises a first die 31, which has a top wall 311, a cavity 312 formed in the top wall 311, and a groove 313 formed in the top wall 311 and spaced around the cavity 312, and a second die 32, which has a bottom wall 321, a press block 322 downwardly protruding from the bottom wall 321 corresponding to the cavity 312 of first die 31, and a cutting edge 323 downwardly protruding from the bottom wall 321 and spaced around the press block 322 corresponding to the groove 313 of the first die 31 (see FIG. 2);

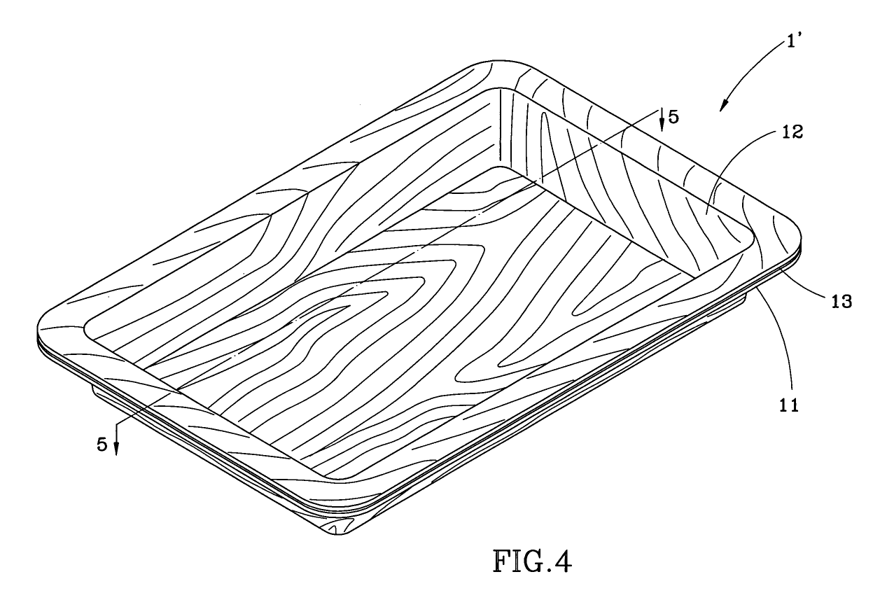

Step IV: placing the blank sheet material 1 on the first die 31 below the second die 2, and then closing the second die 32 on the first die 31 and employing a pressure to the second die 32 against the blank sheet material 1 and the first die 31 at a temperature about 150-180° C., so as to process the blank sheet material 1 into the desired finished container 1′ as shown in FIGS. 4 and 5. The hot compression molding process of Step IV includes three continuously proceeded stages. During the first stage, a pressure about 25-55 kg/cm² is applied to the second die 32 against the blank sheet material 1 and the first die 31, thereby causing the bonding layer 13 to be melted to bond the wooden sheet members 11, 12 together. During the second stage, a pressure about 35-65 kg/cm² is applied to the second die 32 against the blank sheet material 1 and the first die 31, thereby causing the wooden sheet members 11, 12 to be ironed into a respective smooth surface. During the third stage, a pressure about 35-75 kg/cm² is applied to the second die 32 against the blank sheet material 1 and the first die 31 to force the cutting edge 323 completely into the groove 313 of the first die 31 to cut off the border area of the shape-formed blank sheet material 1, and the desired finished container 1′ is thus obtained, as shown in FIGS. 4 and 5.

The finished container 1′ thus obtained is sterilized by a UV (ultraviolet) sterilizer. When a number of finished containers 1′ are obtained and sterilized, they are arranged into stacks and packed by a vacuum packing machine for vending.

According to the above description, the fabrication method of the present invention and/or the laminated wooden container made therefore have the following advantages: nontoxic, not harmful, strong, heat resisting, decomposable, sturdy and rigid structure, and clean to the environment.
1. The laminated wooden container made according to the present invention meets requirements for environmental protection. It has no residue and, is nontoxic, not harmful, strong, heat resisting, microwavable, freezable, decomposable, and clean to the environment. Further, waste laminated wooden containers can be burned to make charcoal, crushed for making furniture, or reclaimed for making paper. The reclamation cost of waste laminated wooden containers is low.
2. Because the invention uses the bonding layer 13 to bond the two wooden sheet members 11, 12 together, during heat sealing, only a small amount of the bonding glue will permeate into the tissues of the wooden sheet members 11, 12. Further, due to the effect of the bonding layer 13, the blank sheet material 1 is tough, and the finished laminated wooden container 1′ does not break easily during its use.
3. Except the eatable bonding layer 13, the invention does not use any water repellent, smoothening agent, or any other chemical substances. The bonding layer 13 makes the container 1′ water-resistant. Further, because the bonding layer 13 is sandwiched between the wooden sheet members 11, 12, it is isolated from contacting the food held in the container 1′. Therefore, the container 1′ is safe in use, and suitable for holding food.
4. Through one single hot compression molding process, the wooden sheet members 11, 12 and the bonding layer 13 are bonded together and shape-formed to have a smooth cutting edge. Because no further secondary processing process is needed, the manufacturing time is greatly shortened, and the manufacturing cost is greatly lowered.

Although particular embodiments of the invention have been described in detail for purposes of illustration, various modifications and enhancements may be made without departing from the spirit and scope of the invention. For example, three wooden sheet members and two bonding layers may be used to make a relatively stronger container through one single hot compression molding process. Accordingly, the invention is not to be limited except as by the appended claims.

What is claimed is:

1. A laminated wooden container comprising:
two surface layers made respectively from a wooden sheet member; and
a bonding layer bonded in between said surface layers, said bonding layer comprising a base sheet material obtained from a fiber material, and a glue covered on two opposite surfaces of said base sheet material.

2. The laminated wooden container as claimed in claim 1, wherein said fiber material is a long fiber.

3. The laminated wooden container as claimed in claim 1, wherein said glue is selected from a group consisting of eatable glue and biological glue.

4. A method of making a laminated wooden container, comprising the steps of:
(a) preparing two wooden sheet members and a bonding layer;
(b) laminating the two wooden sheet members and the bonding layer together to have the bonding layer be sandwiched between the wooden sheet members to form a laminated sheet material;
(c) preparing a hot compression molding mold; and
(d) heat compressing said laminated sheet material by using the hot compression molding mold to form a container.

5. The method as claimed in claim 4, wherein said hot compression molding mold comprises a first die, which supports said laminated sheet material, and a second die, which is closed on said first die and pressed against said laminated sheet material.

6. The method as claimed in claim 5, wherein said hot compression molding mold is heated to seal said laminated sheet material through three continuously proceeded pressure-application procedures, each pressure-application procedure being to apply a different pressure to one die of said hot compression molding mold against the other die of said hot compression molding mold.

7. The method as claimed in claim 6, wherein said step (d) is performed at a temperature ranging from 150° C. to 180° C.

8. The method as claimed in claim 6, wherein said first die has a top wall, a cavity formed in said top wall, and a groove formed in said top wall and spaced around said cavity; said second die has a bottom wall, a press block protruding from said bottom wall for engaging into said cavity of said first die, and a projecting cutting edge protruding from said bottom wall for inserting into said groove of said first die to cut a border material from said laminated sheet material when said laminated sheet material is being sealed by said hot compression molding mold

9. The method as claimed in claim 8, wherein said three continuously proceeded pressure-application stages include:
a first stage to apply a first pressure to said second die against said laminated sheet material and said first die to as to meld said bonding layer and to have said two wooden sheet members be bonded together by said bonding layer;
a second stage to apply a second pressure to said second die against said laminated sheet material and said first die so as to have said wooden sheet members be ironed into a respective smooth surface; and
a third stage to apply a third pressure to force said cutting edge of said second die completely into said groove of said first die to cut off the border area of said laminated sheet material.

10. The method as claimed in claim 9, wherein said first pressure is within 25-55 kg/cm²; said second pressure is within 35-65 kg/cm²; said third pressure is within 35-75 kg/cm².

11. The method as claimed in claim 4, wherein said bonding layer comprises a base sheet material obtained from a natural fiber, and a glue covered on two opposite surfaces of said base sheet material, said glue being an eatable glue or a biological glue.

12. The method as claimed in claim 4, wherein said bonding layer comprises a base sheet material is obtained by dipping a natural long fiber in an eatable glue.

13. A laminated wooden container comprising:
three wooden layers respectively made from a wooden sheet member; and
two bonding layers bonded in between two of said wooden layers, said bonding layers each comprising a base sheet material obtained from a natural fiber material, and a glue covered on two opposite surfaces of said base sheet material.
